(19) United States
(12) Patent Application Publication
(10) Pub. No.: US 2016/0010803 A1
(43) Pub. Date: Jan. 14, 2016

(54) ELIMINATING TURBULENCE IN WALL-BOUNDED FLOWS BY DISTORTING THE FLOW VELOCITY DISTRIBUTION IN A DIRECTION PERPENDICULAR TO THE WALL

(71) Applicant: Institute of Science and Technology Austria, Klosterneuburg (AT)

(72) Inventors: Bjoern Hof, Klosterneuburg (AT); Marc Avila Canellas, Erlangen (DE); Jakob Kuehnen, Klosterneuburg (AT); Baofang Song, Klosterneuburg (AT)

(21) Appl. No.: 14/853,001

(22) Filed: Sep. 14, 2015

Related U.S. Application Data
(63) Continuation-in-part of application No. PCT/EP2014/055329, filed on Mar. 17, 2014.

(30) Foreign Application Priority Data
Mar. 15, 2013 (EP) 13 159 370.9

(51) Int. Cl. F17D 1/20

(52) U.S. Cl. CPC F17D 1/20

(57) ABSTRACT

For eliminating turbulence in a wall-bounded turbulent flow comprising a flow velocity distribution in a direction perpendicular to the wall, the flow velocity distribution in the direction perpendicular to the wall is distorted. This may be done by locally generating additional vortices in the turbulent flow close to the flow-bounding wall, which are distributed over a section of the flow-bounding wall extending in a main flow direction of the turbulent flow, and whose axes predominantly extend parallel to the flow-bounding wall. Distorting the flow velocity distribution in the direction perpendicular to the wall may also be achieved by increasing the flow velocity close to the flow-bounding wall by locally immersing a flow deviating structure in the turbulent flow, or by equalizing the flow velocity distribution in the direction perpendicular to the wall by locally immersing a flow dividing structure in the turbulent flow.

### CROSS REFERENCE TO RELATED APPLICATIONS

This application is a continuation-in-part (CIP) of International Application number PCT/EP2014/055329, filed on Mar. 17, 2014, which claims priority to European Application number EP 13 159 370.9 entitled “Eliminating Turbulence in Wall-Bounded Flows by Distorting the Flow Velocity Distribution in a Direction Perpendicular to the Wall”, filed on Mar. 15, 2013.

### FIELD OF THE INVENTION

The present invention generally relates to a method of and an apparatus for eliminating turbulence in a wall-bounded flow by distorting the flow velocity distribution in a direction perpendicular to the wall.

In a wall-bounded flow, i. e. in a flow of a fluid over a wall, the wall exerts shear forces onto the fluid, and, as a result, a boundary layer of the flow is formed at the flow-bounding wall in which the flow is affected by the wall.

In such a boundary layer, depending on the actual conditions, the flow may be laminar or turbulent, the drag in a boundary layer being much higher with a turbulent flow than with a laminar flow. Thus, a laminar flow often has big advantages over a turbulent flow in that it saves energy, like for example in pumping a liquid through a pipe or channel. Particularly, the present invention relates to flows through pipes.

Even more particularly, the present invention relates to re-laminarizing turbulent flows at Reynolds-numbers above 2700 at which the turbulences in the flows do normally not decay so that the flow normally stays turbulent over its entire downstream extension.

The Reynolds-number as used here is defined in a pipe as Re=ŪD/ν, where Ū is the mean flow speed or average flow velocity, D is the pipe diameter and ν is the kinematic viscosity (so far as a flow through a pipe is concerned; otherwise a corresponding definition of Re for a flow through a channel or over a flow-bounding wall is to be applied).

### BACKGROUND OF THE INVENTION

Björn Hof et al.: Eliminating turbulence in spatially intermittent flows, Science 19, March 2010: Vol. 327, No. 5972, pp. 1491-1494, disclose a method of eliminating turbulence in a spatially intermittent flow through a pipe in that the parabolic velocity profile of a laminar flow is distorted to a plug like velocity profile upstream of a turbulent puff. The distortion of the velocity profile reduces the sudden change of the axial velocity across the rear of the turbulent puff. In numerical simulations, this proposal is reported to be successful in eliminating turbulence. Once having eliminated the turbulent puff, a forcing needed to distort the parabolic velocity profile may even be switched off, and the flow continues to re-laminarize. However, Hof et al. point out, that a distortion of the velocity profile at the turbulent laminar interface cannot be as readily implemented in practice as in simulations. Thus, they proposed to use a second turbulent puff upstream of the original one to distort the velocity profile at the rear end of the original puff. When the second turbulent puff is induced at a short distance upstream of the original puff, the short distance between the two puffs is insufficient to allow a parabolic velocity profile to fully develop, despite the fact that the flow is not turbulent between the two puffs. Hof et al. could show that introducing the additional puff allows for keeping the flow in a pipe laminar downstream of the additional puff, even in the area of the original puff. However, they pointed out that their simple strategy only works well for sufficiently small Reynolds-numbers of Re<2000 in pipes, Re<1400 in channels and Re<1800 in ducts, and that it becomes less efficient as Re increases, and once the regime of spatially expanding turbulence is reached (Re>2500 in pipes) it fails. On the other hand, in their numerical simulations, the basic concept of distorting the velocity profile to re-laminarize a turbulence proved successful even with larger Reynolds-numbers and reduced the drag more than by a factor of two.

WO 2012/069472 A1 discloses a method and an apparatus for eliminating turbulence in a wall-bounded flow by moving a section of the flow-bounding wall in the direction of the flow. The fluid in the boundary layer of the flow which is located close to the moved section of the flow-bounding wall is accelerated as compared to its velocity of zero with a fixed flow-bounding wall. With a constant average velocity of the flow, this results in a distortion of the velocity profile in that the maximum difference in velocity between the fluid in the boundary layer directly adjacent to the flow-bounding wall and the fluid in the centre of the flow or even outside the boundary layer is reduced. As a direct consequence, the shearing forces in the boundary layer feeding turbulence are reduced. The known method is not only able to avoid the occurrence of turbulence but also to re-laminarize an already turbulent flow. If the flow is not disturbed again downstream of the point at which the known method is executed, it may stay laminar indefinitely (Reynolds-number permitting). Thus, a local application of the known method may reduce the drag of a flow over a long distance, like for example an entire pipe or channel. Thus, the known method may be used for strongly decreasing the energy spent for pumping fluids like gases and liquids. The suitable length of the flow over which the moved section should include the full flow-bounding wall depends on the velocity at which the section of the flow-bounding wall is moved. Generally, this length of the flow should be at least about 20 boundary layer thicknesses long. In this context the boundary thickness layer is defined as the thickness over which the flow-bounding wall affects the flow. If the flow-bounding wall encloses a lumen through which the flow flows, like in case of a pipe or a channel, the moved section of the flow-bounding wall generally is at least about 20 diameters of this lumen long. The velocity at which the section of the flow-bounding wall which is moved in the direction of the flow according to the known method is preferably at least about 40% of an average flow velocity of the flow over the unmoved flow-bounding wall.

Although, the method and the apparatus WO 2012/069472 A1 proof to be successful in eliminating turbulence in a wall bounded, their application is quite complicated as continuously moving a section of a flow-bounding wall is not implemented easily.

Thus, a need remains for more easily applied methods and apparatus which eliminate turbulence in a wall-bounded flow by distorting the flow velocity distribution in a direction perpendicular to the wall.

### SUMMARY

In one embodiment, the present invention relates to a method of eliminating turbulence in a wall-bounded turbulent flow comprising a flow velocity distribution in a direction perpendicular to the wall. This method comprises the steps of distorting the flow velocity distribution in the direction perpendicular to the wall by locally generating additional vortices in the turbulent flow close to the flow-bounding wall, wherein the additional vortices are distributed over a section of the flow-bounding wall extending in a main flow direction of the turbulent flow, and wherein axes of the additional vortices predominantly extend parallel to the flow-bounding wall.

In another embodiment, the present invention relates to an apparatus for eliminating turbulence in a wall-bounded turbulent flow by distorting a flow velocity distribution in a direction perpendicular to the wall. This apparatus comprises a plurality of vortex generators which are arranged close to the flow-bounding wall, distributed over a section of the flow-bounding wall extending in a main flow direction of the turbulent flow and configured to generate additional vortices in the turbulent flow whose axes predominantly extend parallel to the flow-bounding wall.

In another embodiment, the present invention relates to a method of eliminating turbulence in a wall-bounded turbulent flow comprising a flow velocity distribution in a direction perpendicular to the wall, the method comprising the step of distorting the flow velocity distribution in the direction perpendicular to the wall by increasing the flow velocity close to the flow-bounding wall by locally immersing a flow deviating structure in the flow.

In another embodiment, the present invention relates to an apparatus for eliminating turbulence in a wall-bounded turbulent flow by distorting a flow velocity distribution in a direction perpendicular to the wall, the apparatus comprising a flow deviating structure immersed in the flow, the flow deviating being configured to increase the flow velocity close to the flow-bounding wall.

In another embodiment, the present invention relates to a further method of eliminating turbulence in a wall-bounded turbulent flow comprising a flow velocity distribution in a direction perpendicular to the wall. This further method comprises the step of distorting the flow velocity distribution in the direction perpendicular to the wall by equalizing the flow velocity distribution in the direction perpendicular to the wall by locally immersing a flow dividing structure in the turbulent flow.

In another embodiment, the present invention relates to a further apparatus for eliminating turbulence in a wall-bounded turbulent flow by distorting a flow velocity distribution in a direction perpendicular to the wall. This further apparatus comprises a flow dividing structure immersed in the flow, which is configured to equalize the flow velocity distribution in the direction perpendicular to the wall.

Both in the further method and the further apparatus, the flow dividing structure at least extends over a cross sectional area of the turbulent flow in which flow velocities in the turbulent flow are above an average velocity of the turbulent flow in the main flow direction of the turbulent flow, and comprises a plurality of densely packed through holes of constant cross-section. The through holes extend in the main flow direction of the turbulent flow, and the length of each through hole is at least three times its diameter.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a plot of the kinetic energy of the turbulence of a flow, starting as a turbulent flow, as a function of time, while, for a limited period of time, the generation of additional vortices close to a wall bounding the flow is simulated.

FIG. 2 shows an example of a flow-deviating structure to be immersed in a turbulent flow for laminarizing the turbulent flow.

FIG. 3 is a plot of the turbulence of a flow, starting as a turbulent flow, as a function of time, while a slip material is simulated at a wall bounding the turbulent flow starting at a certain point in time.

FIG. 4 is a plot of normalized slip velocity at a wall bounding a turbulent flow required to laminarize the flow as a function of the Reynolds-number of the turbulent flow.

FIG. 5 is an example of a flow-dividing structure to be immersed in a turbulent flow for laminarizing the turbulent flow in a front view.

FIG. 6 is an axial sectional view of the flow-dividing structure of FIG. 5.

FIG. 7 is an example of a further flow-dividing structure to be immersed in a turbulent flow for laminarizing the turbulent flow in a front view; and

FIG. 8 is a side view of the flow-dividing structure of FIG. 7.

### DETAILED DESCRIPTION

In one embodiment of the present invention, additional vortices are locally generated in a turbulent flow close to a wall bounding the flow. These vortices are “additional” vortices as the turbulent flow already includes vortices due to its turbulence. The additional vortices mix up the distribution of the flow velocities in a main flow direction of the turbulent flow, the turbulent flow displays in a direction perpendicular to the flow-bounding wall. Without the additional vortices the flow velocity distribution of the turbulent flow is plug-shaped with a sharp drop in velocity towards the wall. This sharp drop of the flow velocities causes shearing forces continuously feeding the turbulence of the turbulent flow. As a result, this turbulence does not decay with higher Reynolds-numbers than about 2,700. The additional vortices, however, mix up this plug-shaped flow velocity distribution. Particularly, they mix up partial volumes of the flow of higher flow velocity from the centre of the flow with those of lower flow velocity from the boundary of the flow. As a result, the sharp velocity gradient is pushed closer to the flow-bounding wall, and overall a more uniform flow velocity distribution is achieved which does no longer feed the turbulence of the turbulent flow. In fact, the additional vortices cause a decay of the turbulence of the turbulent flow if generated over a section of the flow-bounding wall extending over a sufficient length in the main flow direction of the turbulent flow. This sufficient length depends on the parameters of the additional vortices. With stronger additional vortices, the sufficient length will be shorter than with weaker vortices. More details with regard to the sufficient length will be given below. Axes of the additional vortices should be oriented such that the additional vortices effectively mix up the flow velocity distribution of the turbulent flow in the direction perpendicular to the wall. For this purpose, the additional vortices should at least predominantly extend parallel to the flow-bounding wall. They may extend in parallel to the main direction of the turbulent flow over the flow-bounding wall. They may, however, also extend in circumferential direction along the flow-bounding wall. Once the turbulence of the turbulent flow has decayed downstream of the local generation of the additional vortices, the flow remains laminar as long as no new turbulence is induced. In fact, the flow may stay laminar forever. If, however, a new turbulence is induced, additional vortices may again be locally generated to also cause a decay of this new turbulence.

It has to be regarded as very surprising that the generation of additional turbulences in a turbulent flow is a suitable means to cause a decay of the turbulence of the turbulent flow, i.e. to laminarize the flow. Normally, generating vortices in a flow just poses the danger of the flow becoming turbulent.

In a more detailed embodiment of the present invention, the additional vortices are generated by injecting fluid into the turbulent flow through the flow-bounding wall. This is an easy way of generating the additional vortices with a suitable direction of their axes. The fluid injected into the turbulent flow may be the same fluid constituting the turbulent flow. Particularly, the fluid injected into the turbulent flow may be taken from the flow.

For the purpose of achieving the desired decay of the turbulence of the turbulent flow, the fluid should be injected at a velocity of at least about 15%, preferably of at least about 20%, and more preferably of at least about 25% of an average velocity of the turbulent flow in the main flow direction of the turbulent flow. The desired effect of the additional vortices, i. e. mixing up the flow velocity distribution, is achieved if the additional vortices increase the velocity components of the turbulences of the turbulent flow in the direction perpendicular to the wall to a relevant extent. As the velocities of the turbulences are typically in the order of 5% of the average velocity of the turbulent flow in the main flow direction, the above mentioned velocities of the fluid injected will cause the desired mixing up of the flow velocity distribution, even if a limited volume of fluid is injected into the flow.

Most efficiently, the fluid is injected into the turbulent flow perpendicularly to the flow-bounding wall and thus also perpendicularly to the main direction of the flow to have the desired direction of the axis of the additional vortices.

Even more particularly, the additional vortices may be generated by injecting the fluid through nozzles into the turbulent flow. Preferably, theses nozzles are evenly distributed over the section of the flow-bounding wall in which the additional vortices are generated.

In an alternative embodiment of the present invention, the additional vortices are generated with rotationally driven vortex generators immersed in the turbulent flow and distributed over the section of the flow-bounding wall in which the additional vortices are generated. These rotationally driven vortex generators may be made as propellers or impellers, for example. The blades of such propellers and impellers may be arranged and rotationally driven in such a way that the blades, besides generating vortices, directly increase the flow velocity of the turbulent flow close to the flow-bounding wall and/or directly decrease the flow velocity of the turbulent flow further away from the flow-bounding wall, like for example in the centre of a pipe enclosing the turbulent flow. In this way, the flow velocity distribution may additionally be distorted as desired to cause a decay of the turbulence of the turbulent flow.

The section of the flow-bounding wall in which the additional vortices are generated according to the present invention, should extend over a length of the flow which is at least about 5 times, preferably at least about 10 times and more preferably at least about 15 times the thickness of a boundary layer of the turbulent flow at the flow-bounding wall. The boundary layer of the turbulent flow is that part of the turbulent flow affected by the flow-bounding wall in that the flow velocity in the main direction of flow is reduced to a relevant extent as compared to those areas of the flow farther away from the flow-bounding wall.

With the flow-bounding wall enclosing a lumen through which the turbulent flow flows, like in case of a pipe, the length of the section of the flow-bounding wall in which the additional vortices are generated should be at least about 5 times, preferably at least about 10 times and more preferably at least about 15 times the diameter of this lumen.

The effect of the generated additional vortices with regard to the desired decay of the turbulence of the turbulent flow may be enhanced in that the flow-bounding wall is locally covered with a slip material allowing for a velocity of the flow at the boundary to the wall of at least about 20%, more preferably at least about 40% of an average velocity of the flow in the main direction of flow even without any additional vortices. This local wall covering may be provided in the and/or downstream of the section of the flow-bounding wall in which the additional vortices are generated. The slip material generally reduces the shearing forces in the flow occurring at the flow-bounding wall and continuously feeding the turbulence of the turbulent flow.

In one embodiment of the present invention, an apparatus for eliminating turbulence in a wall-bounded turbulent flow by distorting the flow velocity distribution in a direction perpendicular to the wall comprises a plurality of vortex generators which are (i) arranged close to the flow-bounding wall, (ii) distributed over a section of the flow-bounding wall extending in an main flow direction of the turbulent flow, and (iii) configured to generate additional vortices in the turbulent flow whose axes predominantly extend parallel to the flow-bounding wall.

Particularly, the plurality vortex generators may include nozzles evenly distributed over the section of the flow-bounding wall and configured to inject fluid into the turbulent flow through the flow-bounding wall, and/or rotationally driven vortex generators immersed in the flow. A cross section of the nozzles may be circular or elongated, i. e. slot-shaped, either in the main direction of the flow or perpendicular thereto.

For the purpose of enhancing the effect of the vortex generators, the flow-bounding wall, in the and/or downstream of the section of the flow-bounding wall in which the vortex generators are provided, may be locally covered with a slip material allowing for a velocity of the flow at the boundary to the wall of at least about 20%, more preferably at least about 40% of an average velocity of the flow in the main direction of the flow, even without any additional vortices generated in the turbulent flow.

Such slip materials are generally known. Their very low friction property may be based on a layer of small gas bubbles arranged between the actual flow-bounding wall and the flow. Some enhancing effect on the decay of the turbulence in the turbulent flow is already achieved with any essential reduction in the friction between the flow and the flow-bounding wall. Thus, a particularly smooth surface of the flow-bounding wall is already an advantage, and a slip material only allowing for a lower velocity of the flow at the boundary to the wall of less than 40% of an average velocity of the flow in the main direction of the flow is a bigger advantage than an ordinary very smooth surface of the flow-bounding wall.

Using a slip material for reducing the flow resistance of a flow flowing over a flow-bounding wall may be regarded as obvious. The above embodiments of the present invention, however, limit the use of such a slip material to a limited section of the flow-bounding wall. Over this section, if its extension in the main flow direction of the turbulent flow is selected appropriately, the turbulence of an incoming turbulent flow decays. Thus, downstream of the section of the flow-bounding wall with the slip material, the flow is laminar and stays laminar even though the flow-bounding wall is no longer covered with the slip material. Thus, very little of the slip material is needed to achieve a global drop in flow resistance according to these embodiments of the present invention.

The length of the section of the flow-bounding wall in which the slip material should be provided to cause a decay of the turbulence of the turbulent flow should be at least about 20 times, preferably at least about 25 times and more preferably at least about 30 times the thickness of a boundary layer of the turbulent flow at the flow-bounding wall, or, with the flow-bounding wall enclosing a lumen through which a turbulent flow flows, like in case of a pipe, it should be at least about 20 times, preferably about 25 times and more preferably at least about 30 time the diameter of the lumen.

In another embodiment of the present invention, a method of eliminating turbulence in a wall-bounded turbulent flow by distorting the flow velocity distribution in a direction perpendicular to the wall comprises the step of increasing the flow velocity close to the flow-bounding wall by locally immersing a flow deviating structure in the flow. The flow deviating structure is a passive means deviating the flow in such a way that the flow velocity in the main direction of flow is increased close to the flow-bounding wall, additionally the flow velocity in the main direction of flow may be reduced in the centre of the turbulent flow.

In another embodiment of the present invention, an apparatus for eliminating turbulence in a wall-bounded turbulent flow by distorting the flow velocity distribution in a direction perpendicular to the wall comprises a flow deviating structure immersed in the flow. The flow deviating structure is configured to increase the flow velocity close to the flow-bounding wall. Particularly, the flow deviating structure may be coaxially arranged in a pipe of circular cross-section enclosing the flow. For example, the flow deviating structure may include coaxial rings whose distances increase towards the flow-bounding wall, and/or at least one centrally closed flow deviating body formed as a solid of revolution. Due to the distances of the rings increasing towards the flow-bounding wall, the flow resistance of the rings decreases towards the flow-bounding wall. As a result, the velocity distribution of the original turbulent flow is distorted as desired. The centrally closed flow deviating body formed as a solid of revolution blocks the central area of the pipe and thus strongly increases the velocity of the flow in those areas close to the flow-bounding wall.

In a further embodiment of the present invention, a method of eliminating turbulence in a wall-bounded turbulent flow by distorting the flow velocity distribution in a direction perpendicular to the wall comprises the step of equalizing the flow velocity distribution in the direction perpendicular to the wall by locally immersing a flow dividing structure in the turbulent flow. A corresponding apparatus comprises a flow dividing structure immersed in the flow which is configured to equalize the flow velocity distribution in the direction perpendicular to the wall. The flow dividing structure divides up the turbulent flow in a plurality of partial flows. The basic concept of this embodiment of the invention is to equalize the flow velocity distribution over the turbulent flow to avoid shearing forces between parts of the flow continuously feeding the turbulence in the turbulent flow.

Further, the diameter of each partial flow is much smaller than the diameter of the entire turbulent flow. As a result, the Reynolds-number of each partial flow is much smaller than the Reynolds-number of the entire turbulent flow. Even with a Reynolds-number of several thousand of the entire turbulent flow, for example, the Reynolds-number of the partial flows may be as low as a few hundred. With these low Reynolds-numbers the turbulence can not survive in the partial flows. When the partial flows get out of the flow dividing structure, the flow is quite disordered again and not yet necessarily laminar. However, the flow velocity profile is very flat, and hence all disturbances decay within about 10 diameters of the flow resulting in a laminar flow further downstream.

Additionally, dividing the turbulent flow into the plurality of partial flows interrupts all vortices extending over more than one of the partial flows. This already decreases the level of turbulence getting into and through the flow dividing structure.

The flow dividing structure at least extends over a cross-sectional area of the turbulent flow in which flow velocities in the turbulent flow are above an average velocity of the turbulent flow in the main flow direction of the turbulent flow. This typically applies to the center area of the turbulent flow at a distance to the flow-bounding wall. However, it is preferred that the flow dividing structure extends over the entire turbulent flow.

Further, it has been noticed that there is no useful effect of providing different designs of the flow dividing structure for different partial flows of the turbulent flow. Instead, with a suitable dimension in the main flow direction of the turbulent flow, the flow dividing structure automatically levels out all differences between the partial flows without such a measure. Thus, it is preferred that the flow dividing structure has the same thickness in the main flow direction of the turbulent flow and the same design over the entire turbulent flow.

Particularly, the flow dividing structure comprises a plurality of densely packed through holes of constant cross-section which extend in the main flow direction of the turbulent flow. The partial flows of the turbulent flow each pass through one of the through holes. The length of each through hole is at least three times its diameter so that the reduced Reynolds-numbers in the through holes are effective for a sufficient time for a decay of the turbulences in the partial flows. Preferably, the length of each through hole is at least five times, more preferably it is at least ten times and most preferably it is at least 15 times its diameter. There is, however, no positive effect of much longer through holes. Thus, there is little use in a length of each through hole of more than 20 times its diameter.

The diameter of each through hole should not be more than 20% of an average diameter of the turbulent flow reducing the Reynolds-number of the partial flow through the through hole to about 20% of the Reynolds-number of the turbulent flow divided by the porosity of the flow dividing structure. With a porosity of a least 50% the Reynolds-number of the partial flow through the through hole is reduced to not more than 40% of the Reynolds-number of the turbulent flow. More preferably, the diameter of each through hole is at maximum 10%, and most preferably it is at maximum 5% of the average diameter of the turbulent flow.

The through holes may have an angular or rounded diameter. Preferably, they may have a circular or hexagonal diameter. Through holes of circular diameter and, particularly, through holes of hexagonal diameter may be packed very densely thus providing a high porosity of the flow dividing structure. Both through holes of circular diameter and through holes of hexagonal diameter may be densely packed in a hexagonal arrangement. In case of through holes of hexagonal diameter, this results in a honeycomb structure as the flow dividing structure. Through holes of circular diameter may also be densely packed in circles around a common centre.

Further, the porosity of the flow dividing structure should be as high as possible. A high porosity, i. e. a low cross-sectional area reduces the drag to the flow induced by the flow dividing structure and a step in free cross-section at the downstream end of the flow dividing structure at which new turbulences may be generated. Preferably, the porosity of the flow dividing structure is at least 50%.

Actually, the flow dividing structure may be made of a bundle of thin-walled tubes, each tube enclosing one of the through holes. Such a flow dividing structure is very similar to a bundle of straws. Alternatively, the flow dividing structure may comprise a one-part shaped body enclosing the through holes. Through holes of circular cross section may actually be provided as bore holes extending through the shaped body.

The functioning of all embodiments of the present invention has been proven by numeric calculations. The reliability of these numeric calculations has been proven in experimental tests.

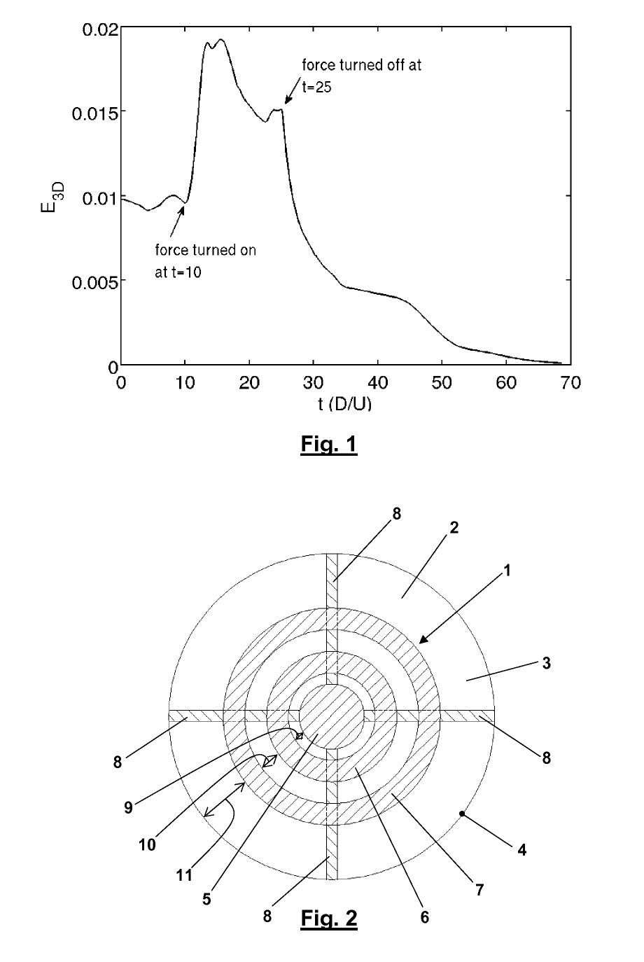

Now referring in greater details to the drawings, FIG. 1 illustrates the results of a numeric simulation of a generation of additional vortices in a turbulent flow. Particularly, the additional vortices have been numerically simulated by a force at the boundary of the flow towards a circular wall enclosing the flow. The force mimics the effect of perpendicularly injecting fluid into the flow at twelve injection points and of withdrawing fluid from the flow at twelve intermediate withdrawal points, the injection and withdrawal points being evenly distributed over the circumference of the flow. In FIG. 1, the kinetic energy of the flow is plotted over the time. The time is indicated in normalized units D/U, wherein D is the diameter of the circular wall and U is the average velocity of the flow in the main direction of the flow over the wall. At a point in time t=10, the force as described above is turned on. At this point in time, the energy of the turbulence in the flow is strongly increased by the force. At a point in time t=25, the force is turned off. Afterwards, the turbulence in the flow strongly drops, indicating a decay of the turbulence of the flow. This decay may be attributed to the fact that due to the distorted flow velocity distribution over the cross-section of the flow, the turbulence of the flow is no longer fed by shearing forces in the boundary area towards the wall and thus decays due to the viscosity of the fluid of the flow. In this way, the turbulent flow is effectively laminarized by generating additional vortices or turbulence in the flow.

FIG. 2 illustrates the arrangement of a flow deviating structure 1 immersed in a flow 2 flowing through a lumen 3 enclosed by a circular wall 4. The flow deviating structure 1 comprises a centrally closed body 5 in the centre of the lumen 3, two rings 6 and 7 coaxially arranged around the body 5 and fins 8 supporting the structure 1 at the wall 4. Distances 9 to 11 between the ring 6 and the central body 5, between the rings 6 and 7, and between the ring 7 and the wall 4 increase towards the wall 4. As a result, the flow deviating structure 1 reduces the flow velocity along the wall 4 in the centre of the lumen 3 and increases the velocity of the flow through the lumen 3 at its boundary towards the wall 4. This corresponds to a suitable distortion of the flow velocity distribution of the turbulent flow for inducing a decay of its turbulence.

FIG. 3 illustrates the results of a simulation of a slip material bounding a turbulent flow. The details of this simulation were a Reynolds-number of the turbulent flow of 20,000 and a normalized slip velocity Vsip (U)=UD/nu, wherein U is the average velocity in the main direction of flow, D is the diameter of the wall bounding the flow, and nu is the kinematic viscosity of the fluid of the flow, of 0.74. At “control on” these slip-conditions have been turned on in the numeric simulation of the turbulence in the flow. After “control on” the turbulence continuously drops (note that the turbulence is plotted at a logarithmic scale; the initial turbulence drops by more than three orders of magnitude). As soon as the turbulence decreases below a threshold value, the turbulence of the turbulent flow completely decays and the flow is laminarized.

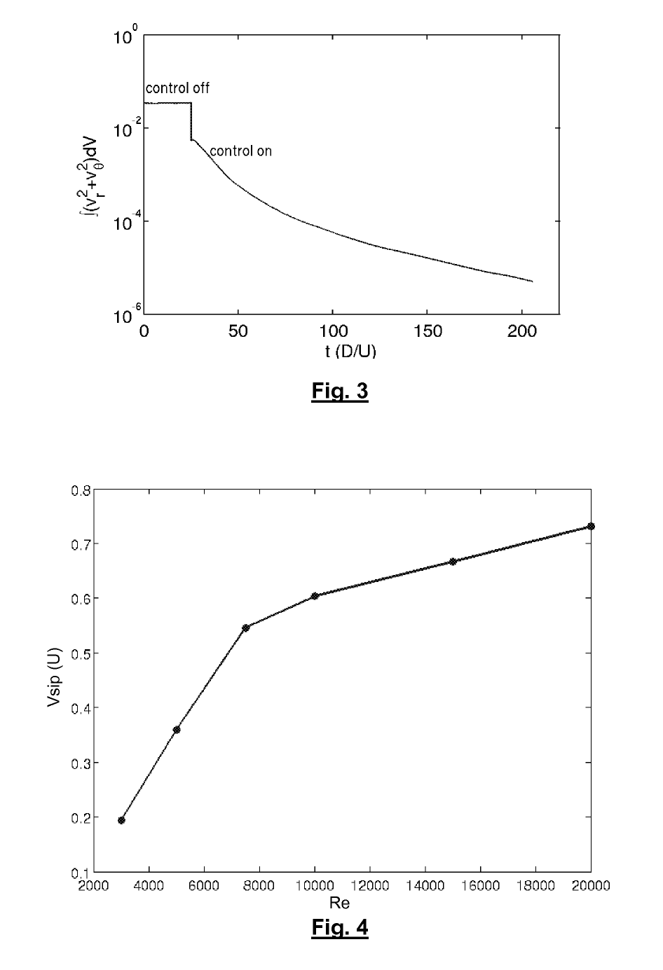

FIG. 4 is a plot of the required normalized velocity of the flow at the flow-bounding wall Vsip which is realized by a slip material as a function of the Reynolds-number of the flow. With increasing Reynolds-numbers of the flow, the normalized velocity of the flow at the wall has to be higher to induce a decay of the turbulence of the flow to have the turbulent flow laminarized.

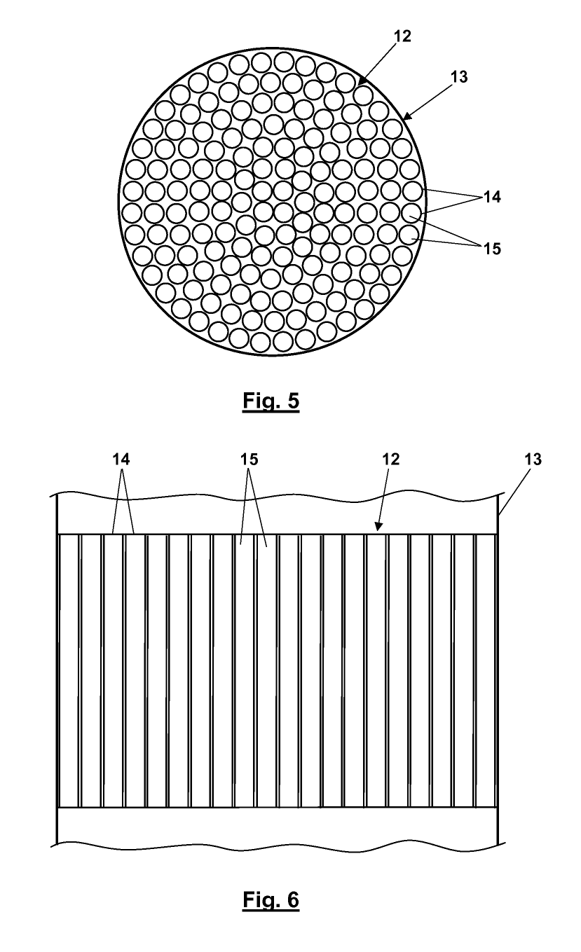

FIGS. 5 and 6 illustrate a flow dividing structure 12 arranged in a pipe 13. The flow dividing structure 12 consists of a plurality or bundle of tubes 14. The tubes 14 are densely packed to fill the entire lumen or free cross-section of the pipe 13. Each tube 14 provides a through hole 15 through the flow dividing structure 12. If a diameter of the through holes 15 is sufficiently small and the through holes 15 are sufficiently long, a turbulent flow through the pipe 13 re-laminarizes. If the pipe diameter is D and the through hole diameter is d, then the ratio D/d should be at least 10. In this case, a re-laminarization has been achieved in experiments at Reynolds-numbers with regard to the turbulent flow through the pipe 13 of less than 3,000. For a ration D/d=30 a re-laminarization has been achieved up to Re=6,000 and slightly above. The effect of the length l of the through holes 15 has also been tested for the ratio D/d=30. With a length of l=5 d, turbulent flows were re-laminarized up to Re=3,800, for l=10 d up to Re=4,800 and for l=17.5 d up to Re=6,000. A further increase of the length l did not extend the Re-range in which a re-laminarization could be achieved. It is assumed that the ratio D/d has to be increased to achieve a re-laminarization at even higher Reynolds-numbers above 6,000. In the reported case of D/d=30, the porosity of the flow dividing structure 12 was 61%, i. e. 39% of the lumen or free cross-section of the pipe 13 were covered by the walls of the tubes 14.

All tubes of the flow dividing structure 12 were of equal length and diameter, and they were densely packed over the entire cross-section of the pipe 13. The tubes 14 located adjacent to the wall of the pipe 13 may be shorter than the tubes 14 in the center of the pipe 13. This, however, does not improve the performance of the flow dividing structure 12 with regard to re-laminarizing a turbulent flow.

Downstream of the flow dividing structure 12 the flow is not yet necessarily laminar. Instead, it may be quite disordered. Typically within 10 D downstream from the flow dividing structure 12, however, the flow will be laminar as the flow velocity profile of the flow is very flat, and hence all disturbances in the partial flows emerging the through holes 15 of the flow dividing structure 12 decay.

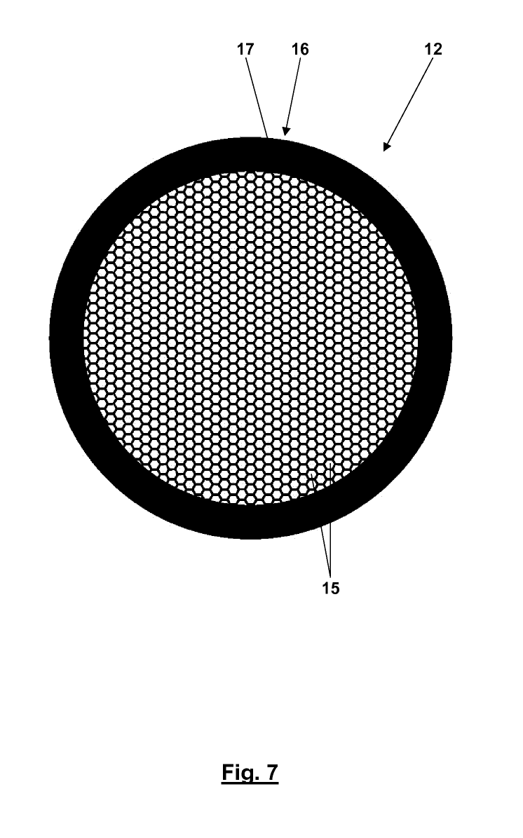

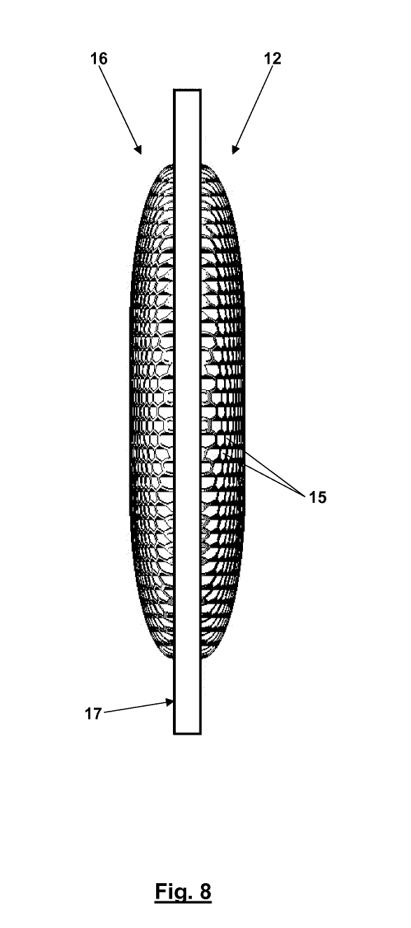

FIGS. 7 and 8 illustrate a further flow dividing structure 12 to be arranged in a pipe. The flow dividing structure consists of a one part shaped body 16. The one part shaped body 16 comprises a rim or flange 17 for mounting the flow dividing structure 12 between tube sections defining the pipe. Further, the flow dividing structure, within the rim or flange 17 comprises the through holes 15, which are of hexagonal diameter here. The through holes 15 have a length decreasing from a center of a turbulent flow through the pipe, where the length of the through holes is essentially constant towards the rim or flange 17, i. e. towards the wall bounding the turbulent flow. This decrease in length of the through holes 15 is by more than 50% of their maximum length in the center of the turbulent flow. The course of the decrease in length of the through holes 15 is no straight line but an increasing decline towards the boundary of the turbulent flow. Even the shortest through holes 15 have a length which is about three times their diameter. The flow dividing structure 12 according to FIGS. 7 and 8 is particularly effective in re-laminarizing a turbulent flow.

Many variations and modifications may be made to the preferred embodiments of the invention without departing substantially from the spirit and principles of the invention. All such modifications and variations are intended to be included herein within the scope of the present invention, as defined by the following claims.

We claim:

1. A method of eliminating turbulence in a wall-bounded turbulent flow comprising a flow velocity distribution in a direction perpendicular to the wall, the method comprising the step of:
distorting the flow velocity distribution in the direction perpendicular to the wall by locally generating additional vortices in the turbulent flow close to the flow-bounding wall,
wherein the additional vortices are distributed over a section of the flow-bounding wall extending in a main flow direction of the turbulent flow, and
wherein axes of the additional vortices predominantly extend parallel to the flow-bounding wall.

2. The method of claim 1, wherein the additional vortices are generated by injecting fluid into the turbulent flow through the flow-bounding wall, and wherein the fluid is taken from the flow.

3. The method of claim 2, wherein the fluid is injected at a velocity of at least about 25% of an average velocity of the turbulent flow in the main flow direction of the turbulent flow, and wherein the fluid is injected into the flow perpendicularly to the flow-bounding wall.

4. The method of claim 1, wherein the additional vortices are generated with rotationally driven vortex generators immersed in the turbulent flow and distributed over the section of the flow-bounding wall.

5. The method of claim 1, wherein the section of the flow-bounding wall extends
over a length of the flow which is at least about 15 times a thickness of a boundary layer of the turbulent flow at the flow-bounding wall, or,
with the flow-bounding wall enclosing a lumen through which the turbulent flow flows, over a length of the flow which is at least about 15 times a diameter of the lumen.

6. An apparatus for eliminating turbulence in a wall-bounded turbulent flow by distorting a flow velocity distribution in a direction perpendicular to the wall, the apparatus comprising:
a plurality of vortex generators which are
arranged close to the flow-bounding wall,
distributed over a section of the flow-bounding wall extending in a main flow direction of the turbulent flow and
configured to generate additional vortices in the turbulent flow whose axes predominantly extend parallel to the flow-bounding wall.

7. The apparatus of claim 6, wherein the plurality of vortex generators include at least one of
nozzles evenly distributed over the section of the flow-bounding wall and configured to inject fluid into the turbulent flow through the flow-bounding wall, and
rotationally driven vortex generators immersed in the turbulent flow.

8. The apparatus of claim 6, wherein the flow-bounding wall, in the section of the flow-bounding wall, downstream of the section of the flow-bounding wall, or both in the and downstream of the section of the flow-bounding wall, is locally covered with a slip material allowing for a velocity of the flow at the boundary to the wall of at least about 40% of an average velocity of the turbulent flow in the main direction of the turbulent flow.

9. A method of eliminating turbulence in a wall-bounded turbulent flow comprising a flow velocity distribution in a direction perpendicular to the wall, the method comprising the step of:
distorting the flow velocity distribution in the direction perpendicular to the wall by increasing the flow velocity close to the flow-bounding wall by locally immersing a flow deviating structure in the turbulent flow.

10. An apparatus for eliminating turbulence in a wall-bounded turbulent flow by distorting a flow velocity distribution in a direction perpendicular to the wall, the apparatus comprising:
a flow deviating structure immersed in the turbulent flow, the flow deviating being configured to increase the flow velocity close to the flow-bounding wall.

11. The apparatus of claim 10, wherein the flow deviating structure is coaxially arranged in a pipe of circular cross-section, and wherein the flow deviating structure includes at least one of coaxial rings whose radial distances increase towards the flow-bounding wall and a centrally closed flow deviating body formed as a solid of revolution.

12. A method of eliminating turbulence in a wall-bounded turbulent flow comprising a flow velocity distribution in a direction perpendicular to the wall, the method comprising the step of:
distorting the flow velocity distribution in the direction perpendicular to the wall by equalizing the flow velocity distribution in the direction perpendicular to the wall by locally immersing a flow dividing structure in the turbulent flow,
the flow dividing structure at least extending over a cross sectional area of the turbulent flow in which flow velocities in the turbulent flow are above an average velocity of the turbulent flow in the main flow direction of the turbulent flow,
the flow dividing structure comprising a plurality of densely packed through holes of constant cross-section,
the through holes extending in the main flow direction of the turbulent flow, and
a length of at least most of the through holes being at least three times its diameter.

13. The method of claim 12, wherein the flow dividing structure extents over the entire turbulent flow, and wherein diameters of all through holes are equal.

14. The method of claim 13, wherein the length of at least some of the through holes is at least five times its diameter.

15. The method of claim 13, wherein the length of each through hole is not more than twenty times its diameter.

16. The method of claim 13, wherein the lengths of the through holes decreases by at least 50% from a center of the turbulent flow towards the wall bounding the flow.

17. The method of claim 13, wherein the diameter of each through hole is at maximum 5% of an average diameter of the turbulent flow.

18. The method of claim 13, wherein the through holes have a circular or hexagonal diameter.

19. The method of claim 13, wherein a porosity of the flow dividing structure is at least 50%.

20. An apparatus for eliminating turbulence in a wall-bounded turbulent flow by distorting a flow velocity distribution in a direction perpendicular to the wall, the apparatus comprising:
a flow dividing structure immersed in the flow,
the flow dividing structure being configured to equalize the flow velocity distribution in the direction perpendicular to the wall,
the flow dividing structure at least extending over a cross sectional area of the turbulent flow in which flow velocities in the turbulent flow are above an average velocity of the turbulent flow in the main flow direction of the turbulent flow,
the flow dividing structure comprising a plurality of densely packed through holes of constant cross-section,
the through holes extending in the main flow direction of the turbulent flow, and
the length of at least most of the through holes being at least three times its diameter.

21. The apparatus of claim 20, wherein the flow dividing structure extents over the entire turbulent flow, wherein all the through holes have equal circular or hexagonal diameters, and wherein a porosity of the flow dividing structure is at least 50%.

22. The apparatus of claim 20, wherein the lengths of the through holes decreases by at least 50% from a center of the turbulent flow towards the wall bounding the flow.

23. The apparatus of claim 20, wherein the flow dividing structure comprises one of a bundle of thin-walled tubes, each tube enclosing one of the through holes, and a one-part shaped body enclosing the through holes.
